(19) United States
(12) Patent Application Publication
(10) Pub. No.: US 2022/0407848 A1
(43) Pub. Date: Dec. 22, 2022

(54) METHOD FOR SECURE DATA COMMUNICATION IN A COMPUTER NETWORK

(71) Applicant: Inventio AG, Hergiswil (CH)

(72) Inventor: Claudio Colombano, Beckenried (CH)

(21) Appl. No.: 17/755,975

(22) PCT Filed: Nov. 20, 2020
(86) PCT No.: PCT/EP2020/082870

§ 371 Date: May 13, 2022

(30) Foreign Application Priority Data
Nov. 21, 2019 (EP) 19210773.8

(51) Int. Cl. H04L 9/40

(52) U.S. Cl. CPC H04L 63/083; H04L 63/0428

(57) ABSTRACT

A method for communicating data in a computer network between a first computer and a second computer, in particular used in a passenger transport system, and a computer network configured to carry out this method house the first computer and the second computer together in a space protected against unauthorized access. The first computer and the second computer are connected to one another via a first data connection and a second data connection. The second data connection extends exclusively within the protected space and exclusively allows data to be transmitted between the first computer and the second computer. The method includes at least the steps of generating authentication data by the first computer and transmitting the authentication data from the first computer to the second computer via the second data connection.

### FIELD

The present invention relates to a method for communicating data in a computer network and to a computer network configured to carry out this method, in particular in a passenger transport system.

### BACKGROUND

Computers are used in a wide variety of applications for processing data. In many applications, computers must be able to exchange data with other computers. For this purpose, a plurality of computers are connected via data connections to form a computer network.

In many applications, it must be ensured that data are exchanged exclusively between computers that are authorized to exchange data in this way. Computers that are not authorized to exchange data of this kind are not intended to be able to exchange data with other computers in the computer network or to be able to intercept a data exchange between authorized computers.

For this purpose, when data are communicated in a computer network, the authenticity of computers participating in the data communication is usually checked in advance. To this end, the computers that are striving for data communication can exchange authentication data. After the authenticity of the communicating computers has been checked, a previously created list can be used, for example, to check whether the authenticated computers are authorized to communicate with one another.

In some cases, data communication between computers is also encrypted. In other words, data to be communicated are encrypted by a sending computer using previously defined encryption data before they are transmitted to a receiving computer, and are then decrypted again by the receiving computer using correlating encryption data. For example, the sending computer can encrypt the data to be transmitted with a public key of the receiving computer, so that the latter can then decrypt the received data again with the private key thereof, which is to be kept secret and correlates with the public key. Because both computers use correlating encryption data, the authenticity or authorization of the communicating computers is also checked indirectly.

With the described type of data communication between computers in a computer network, it must be ensured that authentication data or encryption data have been exchanged or made known between the computers in advance. It must also be ensured that these authentication data or encryption data are exclusively known to the computers involved, but cannot be read, intercepted or determined in any other way by other computers.

In order to be able to meet the requirements mentioned, a considerable amount of outlay has to be conventionally invested in computer networks in order to be able to ensure that authorized computers can exchange suitable authentication data and then enter into data communication with one another, but also to be able to rule out that unauthorized computers can determine or intercept authentication data of their own accord, in order to then be able to enter into data communication without authorization.

In conventional approaches, it is assumed, for example, that all authentication data from subscribers in a computer network differ from one another and are sufficiently complex so that they cannot be determined by chance or through targeted reverse engineering. Authentication data can be determined for each computer when it is manufactured and can be stored in the computer. However, this may require that there is access to a certified authority computer which is responsible for generating authentication data of this kind. This may require additional complex infrastructure. There may also be a risk that the certified authority computer is intercepted, for example through data leaks, so that unauthorized third parties can gain access to authentication data. Data leaks can be difficult to detect and/or repair. In particular, data leaks can result in authentication data that have already been created for a large number of computers having to be replaced with new authentication data with significant outlay. To increase data security, the authentication data must also have a time-limited validity. However, this may require new authentication data to be transmitted to the computers after this validity has expired, which in turn may require a data connection between the computers and the authority computer.

### SUMMARY

Among other things, there may be a need for a method for communicating data in a computer network, with which at least some of the deficits mentioned at the outset, as occur in the conventional operation of computer networks, can be overcome. In particular, there may be a need for a method for communicating data in a computer network, which method can be implemented easily and/or with little outlay on hardware and which nevertheless allows a high level of security during data communication. There may also be a need for a computer network which is configured to execute or control a method of this kind. Finally, there may be a need for a passenger transport system that is equipped with a computer network of this kind.

Such a need can be met by the subject matter according to the advantageous embodiments that are defined in the following description.

According to a first aspect of the invention, a method for communicating data in a computer network between a first computer and a second computer, in particular in a passenger transport system, is proposed. The first computer and the second computer are housed together in a space protected against unauthorized access. The first computer and the second computer are also connected to one another via a first and a second data connection. The second data connection extends exclusively within the protected space. Furthermore, the second data connection exclusively allows data to be transmitted between the first computer and the second computer. The method comprises at least the following method steps, preferably in the sequence provided:

generating authentication data by means of the first computer, this authentication data containing at least one key to be kept secret;
transmitting the key to be kept secret from the first computer to the second computer via the second data connection; and
setting up encrypted data communication for transmitting data via the first data connection and checking the authenticity of the second computer by means of the first computer based on the authentication data.

According to a second aspect of the invention, a computer network having a first computer and a second computer, in particular in a passenger transport system, is proposed. The first computer and the second computer are housed together in a space protected against unauthorized access. The first computer and the second computer are connected to one another via a first and a second data connection. The second data connection extends exclusively within the protected space. Furthermore, the second data connection exclusively allows data to be transmitted between the first computer and the second computer. The computer network is configured to execute or control the method according to an embodiment of the first aspect of the invention.

According to a third aspect of the invention, a passenger transport system, in particular an elevator system, having a computer network according to an embodiment of the second aspect of the invention is proposed, the protected space being a machine room of the passenger transport system.

Possible features and advantages of embodiments of the invention can be considered, inter alia and without limiting the invention, to be based upon the concepts and findings described below.

As already mentioned in the introduction, in a wide variety of technical applications, a plurality of computers must be able to communicate reliably and securely with one another, i.e. exchange data, via a data network. In many cases, it must be ensured that individual computers only communicate with certain other computers, but do not transmit data to computers that are not authorized for this purpose and/or do not accept data from computers that are not authorized for this purpose. To do this, computers must be able to authenticate themselves, i.e. a computer must be able to reliably determine the identity of another computer that is a possible communication partner and, on the basis of the identity determined, be able to determine whether data exchange with this computer is permissible.

In this context, a first computer and a second computer can be part of a computer network consisting of a large number of computers. The first computer can be a host computer or server computer, for example, and the second computer can be a client computer from a plurality of client computers included in the computer network. All of these computers can be connected to one another via one or more data connections, i.e. in principle they will be able to exchange data with one another via wired or wireless interfaces.

In order for the first computer to be able to exchange data reliably and discreetly with the second computer, it must be possible to ensure that no other computer in the computer network can intercept the data communication between the first and second computers and that no other computer can output to the first computer other than the second computer.

For this purpose, it must generally be ensured that the second computer can authenticate itself to the first computer, so that the first computer can be certain of the identity of the second computer and can then, based on the identity ascertained in this way, determine whether data communication with the second computer is permissible, i.e. whether the second computer is authorized to exchange data with the first computer.

In order to be able to meet the stated requirements at least in certain applications, a specially configured method for communicating data via a data network between a first computer and a second computer and a computer network configured to carry out this method are presented herein.

A prerequisite for the functioning of the method presented here is that the first computer and the second computer are housed together in a space protected against unauthorized access, i.e. that they are located in the immediate vicinity of one another. A space of this kind can be understood as a physically delimited region to which exclusively persons authorized for this purpose normally have access. A space of this kind can be, for example, a volume surrounded by walls or other physical boundaries in a building or structure, which can exclusively be accessed via one or more lockable doors or the like. In order to get through such a door into the protected space, a person must be authorized beforehand, for example by being in possession of a key suitable for unlocking the door. It can therefore be assumed with a very high degree of probability that exclusively persons authorized for this purpose can gain access to the first and second computers housed inside the protected space. Such a person can be, for example, a technician who is responsible for the installation, configuration or maintenance of these computers.

In the specific application in which the first and the second computers are part of a computer network of a passenger transport system such as an elevator system, an escalator or a moving walkway, the space protected against unauthorized access can be a machine room of the passenger transport system, for example.

A machine room of this kind can typically be locked and is thus secured against unauthorized access. A machine room typically houses both a prime mover and a control unit used to control this prime mover. In modern passenger transport systems, this control unit usually has a computer, which can be viewed here as the first computer or host computer. This first computer may need to communicate with a variety of other computers, which in certain cases may be considered herein as second computers or client computers. Some of these computers may be located within the machine room, while other computers may be located outside the machine room.

An example of a second computer which is located within the machine room can, for example, be a computer which is intended to be able to communicate with the first computer for maintenance purposes or for troubleshooting and for this purpose to be able to exchange data with the first computer. The second computer can be permanently installed in the protected space. Alternatively, the second computer can be temporarily brought into the protected space, for example by a maintenance device controlled by the second computer being temporarily brought into the machine room by a maintenance technician.

The first and the second computer are intended to be connected to one another both via a first data connection and via a second data connection. Data from the first computer to the second computer and/or from the second computer to the first computer can be exchanged between the two computers via each of the two data connections.

Each of the two data connections can be physically configured in different ways. A data connection can be wired, i.e. data can be transmitted between the two computers via devices and/or cables connecting the computers. Alternatively, a data connection can be wireless, i.e. data can be transmitted between the two computers via radio, for example.

It is essential that the second data connection extends exclusively within the protected space. In other words, the second data connection is intended to exclusively be able to be implemented if both the first computer and the second computer are within the protected space. In yet other words, the second data connection is intended to neither be able to be established from outside the protected space nor be intercepted from outside the protected space.

In the communication method proposed here, authentication data are first intended to be generated by the first computer, by means of which the second computer can authenticate itself on the first computer. The authentication data contain at least one key to be kept secret. The key to be kept secret is transmitted from the first computer to the second computer via the second data connection. The key to be kept secret can, for example, be part of a key pair consisting of a public key and a private key that correlates therewith. In particular, the key to be kept secret can be the private key of such a key pair.

However, the first computer does not send the key to be kept secret contained in these authentication data via the first data connection, but via the second data connection to the second computer. In this way, the first computer can be sure that the secret key contained in the authentication data has been sent to a computer located within the protected space. The first computer can thus assume that the second computer receiving the key to be kept secret is authorized for data exchange with the first computer, since otherwise it would not have been allowed to enter the protected space. Furthermore, the first computer can assume that the secret key can only be known to a second computer that is authorized to communicate with the first computer.

After the second computer has received at least the key to be kept secret, encrypted data communication is set up between the first and the second computer, the authentication data being used at least for the authentication of the second computer by the first computer.

However, this data communication is not set up via the second data connection, but via the first data connection, via which the first computer is also connected to other computers and which generally has different data transmission properties than the second data connection.

The first computer can thus check the authenticity of the second computer as part of the encrypted data communication that has been set up.

The method described and the computer network specially configured for this purpose can ensure that data communication required for specific applications can be set up by the first computer only with computers authorized for this purpose and located within the protected space. The data communication protected in this way can be set up with very simple hardware means.

According to one embodiment, the first data connection is configured for data communication at a higher data transmission rate than the second data connection.

In other words, due to the physical design thereof and/or the hardware and software used therefor, the first data connection can be designed to transmit data at a higher transmission rate than the second data connection. The first data connection can thus be designed for a larger bandwidth than the second data connection. For example, the data transmission rate to be established via the first data connection can be more than twice as high, preferably more than ten times as high, as that of the second data connection. While the first data connection can thus be designed for a high data throughput, the second data connection can be established using technically simpler means, since it only needs to allow a low transmission rate.

According to one embodiment, the first data connection is also accessible to subscribers in the computer network which are located outside the protected space.

In other words, the first data connection can be designed in such a way that computers that are not located within the protected space but are located externally thereto can also communicate with the first computer via said data connection. For example, the first data connection can be part of a local area network (LAN), a wide area network (WAN), or even a global data network such as the Internet, over which a large number of computers inside and outside the protected space can communicate with one other.

According to one embodiment, the first data connection can be an Ethernet connection.

Ethernet connections are a long-established and largely standardized option for data transmission between multiple computers. Ethernet connections employ software in the form of protocols, etc., and hardware in the form of cables, splitters, network cards, etc., which are specified for wired data networks, and which were originally designed for local area networks (LAN). They allow data exchange using data frames between the devices connected in a local area network. Transmission rates of up to 400 gigabit/s are currently possible. In the original form thereof, a data network established with Ethernet connections typically extends over a building, but Ethernet variants using glass fibers can have a range of up to 70 km.

According to one embodiment, the second data connection can exclusively allow data to be transmitted between the first computer and the second computer.

The second data connection can thus differ from the first data connection, which in principle can allow data to be transmitted between the first computer and a large number of other computers. The second data connection can thus ensure that data can exclusively be exchanged via said connection between the first and the second computer, but not with other computers.

According to one embodiment, the second data connection can be a wired data connection.

A wired data connection of this kind can use one or more cables which extend between the first and the second computer and via which these two computers can exclusively exchange data. A wired data connection can be established in a technically simple manner, for example by a data cable being plugged with the plugs thereof at opposite ends into one of the computers in each case. In this case, the data cable establishing the data connection can be shielded, so that data transmitted via the data cable cannot be intercepted from outside. The data are thus transmitted via a wired data connection of this kind exclusively between the two first and second computers arranged in the protected space and can neither be manipulated nor intercepted from outside the protected space.

According to one embodiment, the second data connection can be a serial data connection.

A serial data connection allows data to be transmitted sequentially, for example in the form of individual bits, between communication partners. A serial data connection of this kind can be established with very simple technical means, for example with a single wire or cable, which can optionally be shielded.

According to one embodiment, the second data connection can be a unidirectional data connection.

A unidirectional data connection, which is sometimes also referred to as a monodirectional data connection, can be understood to mean a data connection that exclusively allows data to be transmitted in one direction, but not in the opposite direction. While a cable typically cannot only transmit data unidirectionally, the interfaces to be provided on the first computer and the second computer, which interfaces are connected to the cable and which are part of the data connection, can very well be designed for unidirectional data communication of this kind. For example, the interface provided on the first computer can only be configured to send but not receive data, whereas the interface provided on the second computer can only be designed to receive but not send data. A particularly confidential data transmission can be established using a unidirectional data connection of this kind.

In particular, according to a specific embodiment, it is made possible that via the second data connection data can exclusively be transmitted from the first computer to the second computer.

By a unidirectional data connection of this kind being used for the second data connection between the first computer and the second computer, it can be ensured that data that is to be kept secret, such as the authentication data, can be sent to the second computer from the first computer, but in the opposite direction neither the second computer nor any other computer can transfer data to the first computer. As a result, the security of the data communication can be improved and in particular a risk of the first computer being manipulated can be reduced.

According to one embodiment, the key to be kept secret is formed by a key for symmetrical data encryption, the key being stored on the first computer and on the second computer.

In other words, the data communication to be established between the first computer and the second computer is a symmetrical encryption according to this embodiment.

According to one embodiment, the key to be kept secret is formed by a private key of the second computer. When the first computer generates the authentication data, a public key corresponding to the private key is created by the first computer. In this case, the authentication data comprise at least the private key and the public key.

In other words, authentication data can include a key pair comprising a private key and a public key, with the private key being transmitted from the first computer to the second computer via the second data connection.

According to one embodiment, the public key is stored on the first computer in a list of authorized keys. In other words, the public key of the second computer is stored on the first computer in such a way that it can be recognized as trustworthy at a later point in time.

In other words, the public key, which is part of a key pair used as authentication data and which is generated by the first computer itself and then stored, is stored as being trustworthy, so that when encrypted data communication is later established for the first computer, it is evident that the associated communication partner computer is trustworthy, i.e. authorized.

According to one embodiment, the public key is signed by the first computer and this signed key forms the authentication data together with the private key. The signed key can also be transmitted to the second computer. The signed key is also referred to as a certificate or can form a certificate.

Thus, for example, the second computer can set up an encrypted connection between the second computer and the first computer using Transport Layer Security or using Secure Sockets Layer, with the first computer being able to check the authenticity of the second computer. The second computer can dispense with checking the authenticity of the first computer. However, this could be done optionally.

It should be noted that some of the possible features and advantages of the invention are described herein with reference to different embodiments of a communication method and of a computer network designed for carrying out this method. A person skilled in the art recognizes that the features can be transferred, combined, adapted or replaced as appropriate in order to arrive at further embodiments of the invention.

Embodiments of the invention will be described below with reference to the accompanying drawing, with neither the drawing nor the description being intended to be interpreted as limiting the invention.

### DESCRIPTION OF THE DRAWINGS

FIG. 1 shows a passenger transport system in the form of an elevator system having a computer network according to an embodiment of the present invention.

The drawing is merely schematic and not to scale. The same reference signs indicate the same or equivalent features.

### DETAILED DESCRIPTION

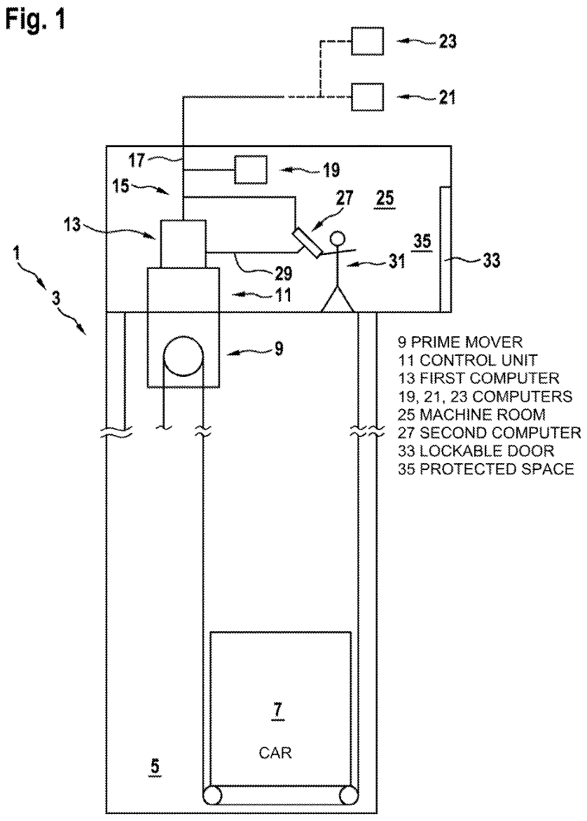

FIG. 1 shows a passenger transport system 1 in the form of an elevator system 3. An elevator car 7 is displaced vertically within an elevator shaft 5 by a prime mover 9. The prime mover 9 is controlled by an elevator control unit 11. The elevator control unit 11 has a first computer 13 or is controlled by that computer.

The first computer is part of a computer network 15 in which a plurality of computers 19, 21, 23 can communicate with the first computer 13 via a first data connection 17. The computers 19 can be accommodated within a machine room 25, in which the control unit 11 and the first computer 13 are also located. Other computers 21, 23 can be located outside of this machine room 25.

The first data connection 17 can be an Ethernet connection and can allow high data transmission rates from, for example, a few kilobits per second and a few megabits per second to a few gigabits per second.

For example, in order to be able to carry out configuration measures or maintenance measures on the passenger transport system 1, in particular on the control unit 11 thereof, it may be necessary to have a second computer 27 exchange data with the first computer 13. The second computer 27 can be part of a maintenance tool, for example, which is brought along and/or operated by a technician 31 in order to configure the control unit 11. The second computer 27 is located within the machine room 25. Since this machine room 25 can exclusively be entered by persons through a lockable door 33, it can be regarded as a space 35 protected against unauthorized access.

The second computer 27 is connected to the first computer 13 via the first data connection 17 and can use this connection to exchange data with the first computer 13 at a high data transmission rate.

In addition, the second computer 27 is also connected to the first computer 13 via a second data connection 29. This second data connection 29 extends exclusively within the machine room 25. It is preferably configured as a wired data connection and is used exclusively for transmitting data between the first computer 13 and the second computer 27. The second data connection 29 is configured as a serial and unidirectional data connection in such a way that it only allows data to be transmitted from the first computer 13 to the second computer 27 in one direction, but not in the opposite direction.

With the computer network 15 described herein and the communication method to be carried out therewith, an approach can be described to make data exchange, and in particular the handling of authentication data and/or encryption data, between two computers 13, 27, which are in close proximity to one another and are located together in a space 35 protected against unauthorized access, secure and easy.

The two computers can take on different roles or perform different tasks. As a server or host computer, the first computer 13 can, for example, control the control unit 11 of the elevator system 3 and therefore be responsible for the correct and safe operation of the elevator system 3. The second computer 27 can be a client computer that is intended to be able to interact with the control unit 11. A client computer of this kind can, for example, display and/or modify status information and can be used for maintenance or troubleshooting of an elevator system 3.

It must be ensured that exclusively authenticated client computers are allowed to interact with the server or host computer and to exchange data in order to thereby ensure the security of the elevator system 3.

The approach proposed herein attempts to simplify the task of the control unit 11 or of first computer 13 thereof to authenticate the second computer 27 acting as a client computer in the protected space 35. In other words, the aim is to ensure that the client computer is authorized to carry out data communication with the control unit 11 or the first computer 13.

The approach described is based, among other things and in particular, on the following assumptions:

i) The client computer and host computer, i.e. the first computer 13 and the second computer 27, are all connected to the same local network, i.e. they can communicate with one another via the common first data connection 17. This network is used as a wide-bandwidth connection and shared by all computers to form a LAN of the elevator system 3.
ii) The client computer, i.e. the second computer 27, is located together with the first computer 13 within the protected space 35, i.e. in close proximity to the first computer 13 with which it is intended to interact.
iii) The protected space 35, i.e. the machine room 25 in the example mentioned, is regarded as trustworthy. It is assumed that this space 35 has sufficient physical barriers, such as the lockable door 33, to prevent unauthorized entry.
iv) The network can also be accessed by other computers 19, 21, 23 which are not necessarily in the vicinity of the first computer 13, i.e. by other computers 21, 23 which are not located within the protected space 35.
v) The data exchange must be secure. This means that exclusively authorized client computers may communicate with the server via the local network.
vi) A wide area network (WAN) such as the Internet may be available to be able to interact with members of the local area network.
vii) The local network, i.e. the first data connection 17, should not be allowed to be used to exchange data that is to be kept secret, such as the authentication data or encryption data to be used accordingly, in order to rule out the possibility of an attacker intercepting the data traffic reading this data.

Conventionally, assumptions or problems of this kind are solved by gradually defining data to be kept secret, for example in the form of software keys or certificates that identify the client computer and are recognized as authentic by the host computer. However, this can pose the following logistical challenges:

I) All data to be kept secret must be different. If this is not the case, reverse-engineering the key or certificate of the client computer can easily make it possible to duplicate or clone data to be kept secret and then install it on fake client computers that are accepted by all controllers in the network.
II) Data to be kept secret such as keys or certificates can be generated at the time of manufacture of a computer or of an assembly so as to be different by a certified authority computer which is responsible for generating keys and certificates of this kind being accessed. While this is possible, it introduces complex additional infrastructure into a manufacturing chain.
III) The mechanisms used by the authority computer that generates the data to be kept secret can exhibit data leaks. This can result in the ability to be able to generate illegal, albeit authenticated, keys or certificates at will.
IV) Data leaks of this kind can be difficult to detect and correct. The latter can require a complex process to invalidate data to be kept secret across an entire network or to replace them with new data.
V) Keys and certificates can have a kind of expiry date, i.e. they can have a limited validity in order to reduce the risk of security gaps with no time limit. However, generating and installing new keys and certificates at, for example, periodic intervals may lead to increased logistical costs, for example when an internet connection is not available and an on-site visit is required to install keys and certificates of this kind.

With the approach proposed here, a parallel connection can be established between the second computer 27 used as the client computer and the first computer 13 used as the server computer, which connection can be assumed to be reliable.

The second data connection 29 can be used, for example, in the form of a short serial cable having physical unidirectional transmission capability from the server computer to the client computer for a secure exchange of data to be kept secret.

For obvious reasons, the cable establishing the second data connection 29 can connect the client computer to the server computer since they are assumed to be in close proximity to one another. The cable can also be assumed to be secured against physical access since it is located in the protected space 35 and is therefore not easily accessible to eavesdropping attacks. An embodiment in which the cable only allows unidirectional data transmission can help make it even more difficult to carry out an eavesdropping attack.

A possible sequence for carrying out an embodiment of the communication method proposed herein can appear as follows:

1) The first computer 13 generates authentication data, by means of which the second computer 27 can authenticate itself to the first computer. The authentication data contain a key to be kept secret of the second computer 27 and a public key of the second computer 27.

2) The first computer 13 stores the public key in a list of authorized keys, for example. This list can later be used to authenticate a client computer such as the second computer 27. The list can be formed, for example, by a file, a database or by a directory structure and files.

Alternatively or additionally, the first computer 13 can also sign the public key of the authentication data with its own private key. The signed, public key of the authentication data is also referred to below as a certificate.

3) The first computer 13 sends the key to be kept secret of the authentication data to the second computer 27 via the serial, preferably unidirectional cable 29, for example using a standard serial protocol such as RS232. The public key of the authentication data or the certificate can also be transmitted to the second computer, with this transmission being able to take place either via the first data connection 17 or via the second data connection 29.

4) After the key to be kept secret of the authentication data has been transmitted via the second data connection 29, the second computer 27 can store it, for example in a permanent data memory. Likewise, the public key of the authentication data or the certificate can be stored if it was transmitted to the second computer 27.

5) The second computer 27 can then use this key to be kept secret in order to establish authenticated data communication with the first computer via the local network, i.e. via the first data connection 17.

6) The first computer 13 can authenticate the second computer 27 since the first computer 13 has the public key which corresponds to the private key of the authentication data in the list of authorized keys. Alternatively, the first computer 13 can check the signature of the certificate.

Furthermore, the data connection between the first computer 13 and the second computer 27 is encrypted. A known encryption method can be used for this purpose, such as Transport Layer Security or Secure Sockets Layer.

Another possible embodiment of a sequence for carrying out the communication method proposed herein when using a symmetrical key can appear as follows:

1) The first computer 13 generates authentication data, by means of which the second computer 27 can authenticate itself to the first computer. The authentication data contain a key to be kept secret.

2) The first computer 13 stores the key to be kept secret in a list of authorized keys to be kept secret, for example. This list can later be used to authenticate the second computer 27.

3) The first computer 13 sends the key to be kept secret to the second computer 27 via the serial, preferably unidirectional cable which forms the second data connection 29. For example, a standard serial protocol such as RS232 can be used for this purpose.

4) After the key to be kept secret has been transmitted via the second data connection 29, the second computer 27 can store it, for example in a permanent data memory.

5) The second computer 27 can then use this key to be kept secret in order to establish authenticated and secured data communication with the first computer 13 via the local network, i.e. via the first data connection 17.

6) The first computer 13 can authenticate the second computer since only the first computer 13 and the second computer 27 know the secret key.

Finally, it should be noted that terms such as “comprising,” “having,” etc. do not preclude other elements or steps, and terms such as “a” or “an” do not preclude a plurality. Furthermore, it should be noted that features or steps which have been described with reference to one of the above embodiments may also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A method for communicating data in a computer network between a first computer and a second computer, the computer network being included in a passenger transport system, wherein the first computer and the second computer are housed together in a space protected against unauthorized access, wherein the first computer and the second computer are connected to one another via a first data connection and a second data connection, and wherein the second data connection extends exclusively within the protected space and exclusively allows data to be transmitted between the first computer and the second computer, the method comprising the steps of:
generating authentication data from the first computer, the authentication data containing at least one key to be kept secret;
transmitting the key to be kept secret from the first computer to the second computer via the second data connection; and
setting up encrypted data communication for transmitting data via the first data connection and checking the authenticity of the second computer by the first computer based on the authentication data.

16. The method according to claim 15 wherein the first data connection is configured for data communication at a higher data transmission rate than a data transmission rate of the second data connection.

17. The method according to claim 15 wherein the first data connection is accessible to subscribers in the computer network, which subscribers are located outside the protected space.

18. The method according to claim 15 wherein the first data connection is an Ethernet connection.

19. The method according to claim 15 wherein the second data connection is a wired data connection.

20. The method according to claim 15 wherein the second data connection is a serial data connection.

21. The method according to claim 15 wherein the second data connection is a unidirectional data connection.

22. The method according to claim 21 wherein data is exclusively transmitted from the first computer to the second computer via the second data connection.

23. The method according to claim 15 wherein the key to be kept secret is formed by a key for symmetrical data encryption, and wherein the key to be kept secret is stored on the first computer and on the second computer.

24. The method according to claim 15 wherein the key to be kept secret is formed by a private key of the second computer, wherein a public key corresponding to the private key is created by the first computer when the authentication data are generated by the first computer, and wherein the authentication data include at least the private key and the public key.

25. The method according to claim 24 wherein the public key is stored on the first computer in a list of authorized keys.

26. The method according to claim 24 wherein the public key is signed by the first computer and the signed public key forms the authentication data together with the private key.

27. A computer network in a passenger transport system, the computer network comprising:
wherein the computer network is adapted to perform or control the method according to claim 15;
the first computer and the second computer;
wherein the first computer and the second computer are housed together in the space protected against unauthorized access;
wherein the first computer and the second computer are connected to one another via the first data connection and a second data connection; and
wherein the second data connection extends exclusively within the protected space and the second data connection exclusively allows data to be transmitted between the first computer and the second computer.

28. A passenger transport system comprising:
wherein the passenger transport system is an elevator system;
the computer network according to claim 27; and
the protected space is a machine room of the elevator system.

29. A method for communicating data in a computer network between a first computer and a second computer, the computer network being included in a passenger transport system, the method comprising the steps of:
wherein the first computer and the second computer are housed together in a space protected against unauthorized access;
connecting the first computer and the second computer to one another via a first data connection and a second data connection;
wherein the second data connection extends exclusively within the protected space and exclusively allows data to be transmitted between the first computer and the second computer;
generating authentication data using the first computer wherein the authentication data contain at least one key to be kept secret;
transmitting the key to be kept secret from the first computer to the second computer via the second data connection; and
setting up encrypted data communication for transmitting data via the first data connection and checking the authenticity of the second computer by the first computer based on the authentication data.
